(19) United States
(12) Patent Application Publication
(10) Pub. No.: US 2007/0087067 A1
(43) Pub. Date: Apr. 19, 2007

(54) Semiconductor die having a protective periphery region and method for forming

(76) Inventors: Yuan Yuan, Austin, TX (US); Chu-Chung Lee, Round Rock, TX (US); Tu-Anh N. Tran, Austin, TX (US); Paul M. Winebarger, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/252,409

(22) Filed: Oct. 18, 2005

(51) Int. Cl. B23B 19/00

(52) U.S. Cl. 425/116

(57) ABSTRACT

A die (10) for an integrated circuit comprising an active area (22) is provided. The die (10) may further comprise a first ring (12) in a peripheral region of the die (10) at least partially surrounding the active area (22), wherein the first ring (12) may comprise a plurality of polygon shaped cells (32, 36). The die (10) may further comprise a second ring (14) surrounding the first ring (12), wherein the second ring (14) may comprise a plurality of polygon shaped cells (32, 36).

### FIELD OF THE INVENTION

The present invention relates generally to semiconductor processing, and more specifically, to a semiconductor die having a protective periphery region.

### RELATED ART

The periphery region of a semiconductor die is typically prone to damage, especially during the packaging processing and reliability testing. Generally, the corners and edges of a semiconductor die are under more stress as compared to the center of the die. For example, during wafer dicing, the die edge could be chipped or cracked otherwise damaged. Also, during packaging processing and reliability testing, the semiconductor die is subjected to thermal cycling, causing additional stress to the corners and edges.

Damage that occurs at the corners and edges of a die easily propagates into the active area of the die, destroying all or parts of the die's interconnection or circuitry and reducing the reliability of devices. For example, cracks may propagate from the edges and corners into the active area of the semiconductor die. Also, the edges and corners are more prone to delamination, which also propagates into the active area, further reducing reliability. Furthermore, technology today uses more materials having low dielectric constant, K, (also referred to as low-K dielectric materials) in fabricating semiconductor die, and these low-K materials typically have low adhesion and mechanical strength, which further exacerbates the problem. Current die protection schemes provide inadequate protection thus resulting in reduced reliability and increased processing cost.

One current die protection scheme used today uses a dual ring scheme having a crack stop ring which prevents passivation cracking and the propagation of these cracks and a seal ring, inside of the crack stop ring, to prevent the ingression of moisture. In this dual ring scheme, the edges of the rings are each formed as a solid continuous line of metal in the various metal layers. The continuous lines of metal within different metal layers are connected to each other through the use of vias in the via layers. However, the vias within each via layer are discontinuous. Therefore, since these rings are formed with solid continuous lines within the various metal layers and the vias are discontinuous within each via layer, propagation of a crack or delamination is not sufficiently prevented, resulting in increased failure of the active circuitry.

### BRIEF DESCRIPTION OF THE DRAWINGS

The present invention is illustrated by way of example and not limited by the accompanying figures, in which like references indicate similar elements, and in which:

FIG. 1 illustrates a top down view of a semiconductor die in accordance with one embodiment of the present invention;

FIG. 2 illustrates an enlarged view of a portion of the semiconductor die of FIG. 1 in accordance with one embodiment of the present invention;

FIG. 3 illustrates a cross-sectional view taken through the portion of the semiconductor die illustrated in FIG. 2 in accordance with one embodiment of the present invention;

FIG. 4 illustrates a further enlarged view of a portion of the semiconductor die illustrated in FIG. 2, in accordance with one embodiment of the present invention; and

FIG. 5 illustrates an enlarged view of a portion of the semiconductor die of FIG. 1 in accordance with another embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE DRAWINGS

In one embodiment of the present invention, a protective periphery region of the die is used to provide protection to the active area of the semiconductor die. In one embodiment, a honeycomb structure is used to form a protective ring around the active area of the semiconductor die in order to provide protection from moisture, cracking, delamination, etc. Alternatively, other polygon structures or a circular structure may be used to form the protective ring.

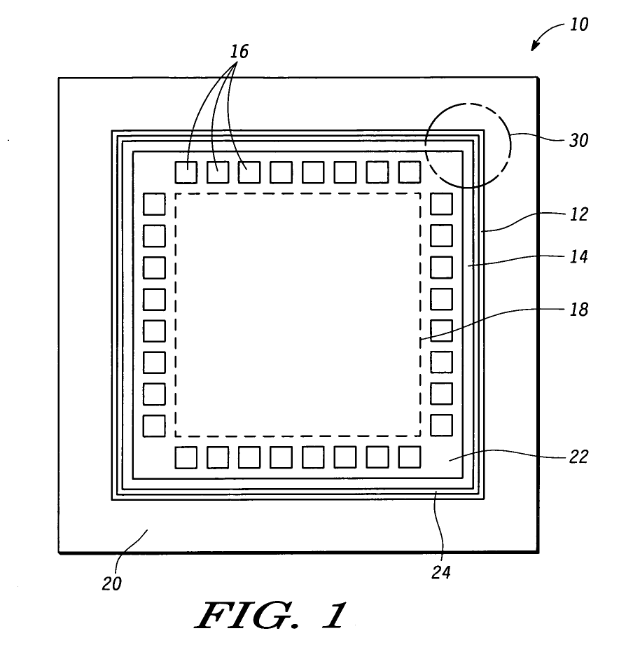

FIG. 1 illustrates a top down view of a semiconductor die 10 in accordance with one embodiment of the present invention. (Alternatively, semiconductor die 10 may be referred to as an integrated circuit die.) Semiconductor die 10 is illustrated as a singulated die having a first protective ring 12 and a second protective ring 14 (also referred to as ring 12 and ring 14). Ring 12 surrounds ring 14 which surrounds an active area 22 of semiconductor die 10. In the illustrated embodiment, active area 22 includes a core area 18 and bond pads 16 around core area 18. Active area 22 and core area 18 may include any type of interconnection and circuitry to implement any variety of functions for semiconductor die 10, where interconnection and circuitry may also be located outside of core area 18 (such as, for example, around or below bond pads 16). Active area 22 of semiconductor die 10, including core area 18 and bond pads 16, may be formed using conventional processing techniques.

FIG. 1 illustrates an example of a peripheral bond pad arrangement with one row of bond pads. Alternatively, the number of rows of bond pads can be more than one. The bond pad arrangement can also be such that the bond pads can be located in an array fashion on top of core area 18. In different embodiments, semiconductor die 10 may not have bond pads 16 for wire bonding connection but may include bump pads for flip chip connection or other landing pad types for other next-level connections.

Semiconductor die 10 also includes a scribe region 20 located outside of ring 12, between the outer edge of ring 12 and the outer edge of semiconductor die 10. In the illustrated embodiment, ring 12 and ring 14 are illustrated as continuous rings; however, in alternate embodiments, these rings may not be continuous. For example, ring 12, ring 14, or both may include one or more gaps. Also, as will be discussed in more detail below, rings 12 and 14 may have different forms other than the rectangular shape form illustrated in FIG. 1. For example, one or both rings may have tapered corners, such that each corner includes an edge that cuts across the corner. Alternatively, the rings may be rounded at the corner. Also, note that ring 12, ring 14, or both may only partially surround the active area. For example, in one embodiment, ring 14 may only partially surround the active area, and ring 12 may then only partially surround ring 14.

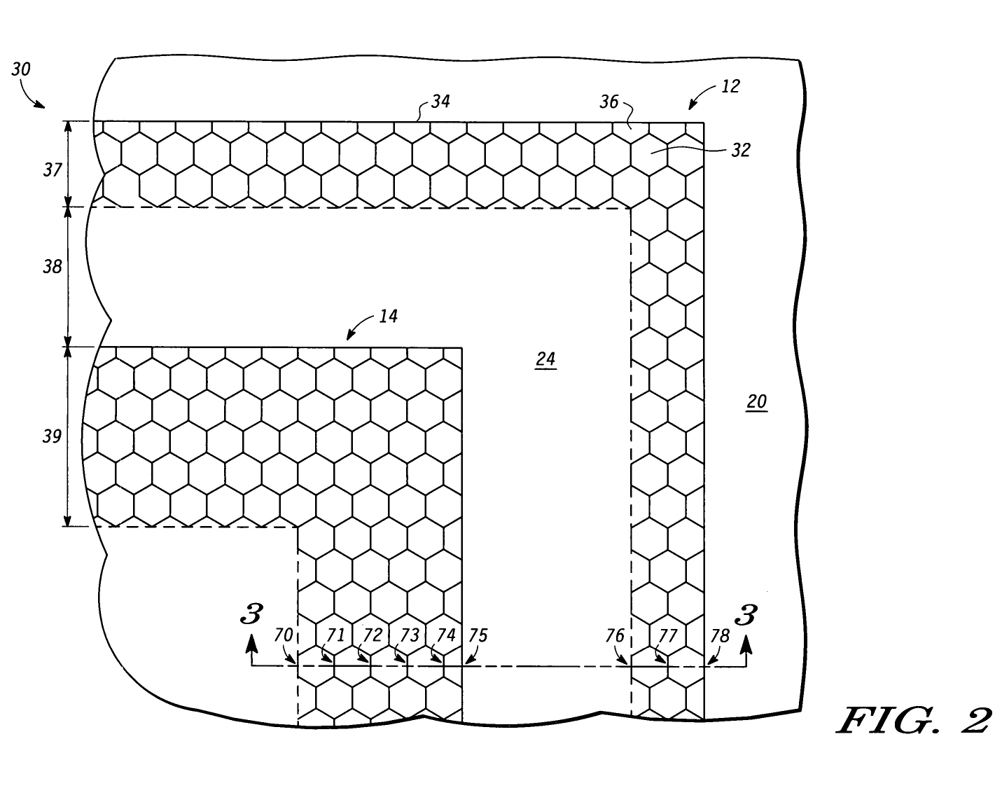

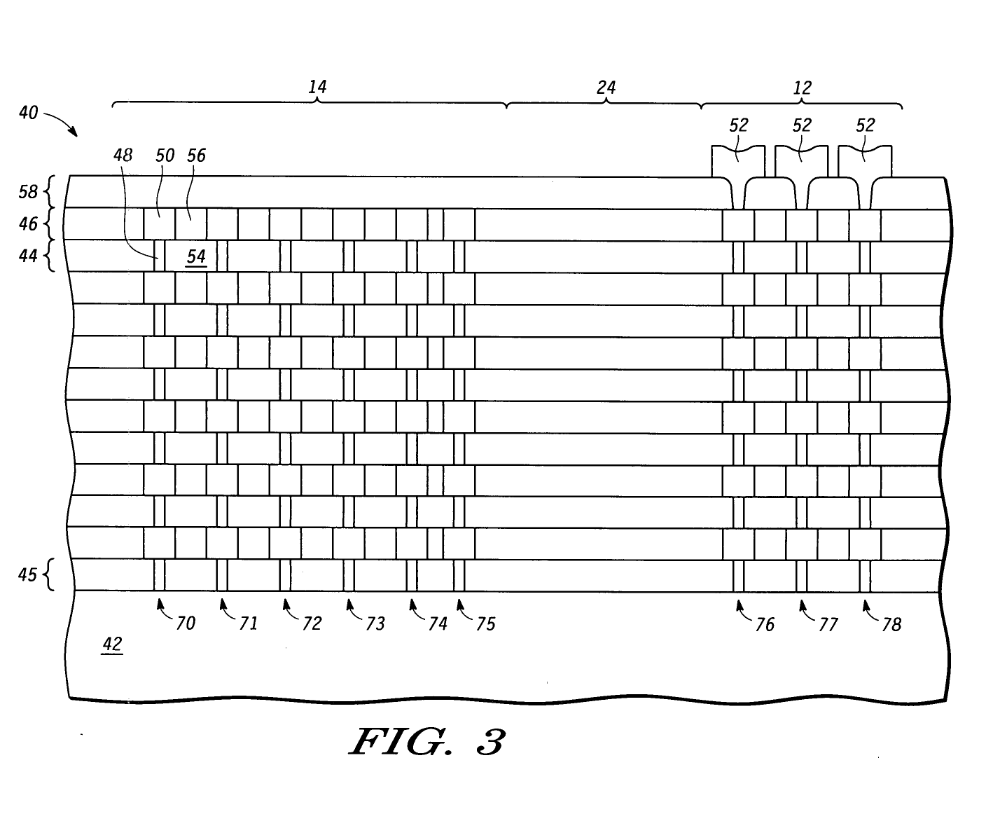

FIG. 2 illustrates an enlarged view of area 30 of semiconductor die 10 of FIG. 1. In the illustrated embodiment, ring 12 is formed as a ring of conductive material having a honeycomb structure. That is, ring 12 includes a number of hexagon cells (also referred to as hexagon shaped cells) formed in a honeycomb structure (including whole hexagons, such as hexagon 32, as well as partial hexagons, such as partial hexagon 36, which are typically formed at the edges of the ring). As will be seen and further described in reference to FIG. 3, the walls of the hexagon cells are formed of a conductive material (such as, for example, copper, aluminum, tungsten, gold, or combinations thereof) and extend down through all interconnect metal layers and via layers to the substrate of the semiconductor die. The inner portions of the hexagon cells are filled with a dielectric material or various dielectric materials. For example, in one embodiment, the hexagon cells include a low-K dielectric material (where low-K, as used herein, refers to a dielectric constant less than 3). Therefore, each hexagon cell has a conductive or metal wall with a dielectric material inside the conductive or metal wall.

Note that in the illustrated embodiment, outer edge 34 of ring 12 is a straight edge formed of a conductive material, such as the conductive material used to form the walls of the hexagon cells. The straight edge of outer edge 34 of ring 12 is accomplished by either stacking whole hexagons (such as hexagon 32) with partial hexagons (such as partial hexagon 36), or stacking partial hexagons together. In the illustrated embodiment, the inner edge of ring 12 does not form a straight edge like the outer edge of ring 12. In an alternate embodiment, the outer edge 34 of ring 12 may not form a straight edge by not using partial hexagons. In another alternate embodiment, the inner edge may also form a straight edge, as shown by the dotted line, by the addition of partial hexagons (similar to partial hexagon 36, along the inner edge).

In one embodiment, a width 37 of ring 12 is approximately 2-4 hexagon cells. In alternate embodiments, width 37 may be smaller or larger to accommodate fewer or more hexagon cells. In one embodiment, width 37 is in a range of approximately 1 to 10 microns. Also, note that the hexagons may be of any size, depending on the desired value of width 37 and the desired number of rows of hexagons. For example, in one embodiment a width of a hexagon cell may be approximately one micron.

In alternate embodiments, the cells of ring 12 may have other polygon shapes. For example, rather than hexagon shaped cells, ring 12 may include pentagon shaped cells or octagon shaped cells, etc., or combinations of different cell shapes. Ring 12 may also include combinations of complete polygon shaped cells and partial polygon shaped cells (similar to complete hexagon shaped cell 32 and partial hexagon shaped cell 36). Alternatively, as will be seen below in reference to FIG. 5, ring 12 may include circle shaped cells (which may also be referred to as circular cells). As with the hexagon cells, each of these polygon shaped cells or circle shaped cells includes a conductive cell wall filled with one or more dielectric materials. Also, note that the corners of ring 12 may be formed in a variety of different forms. For example, more cells may be located at the corners thus resulting in a larger area of cells in the corners than along the edges between the corners.

In the illustrated embodiment, ring 14 is also formed as a ring of conductive material having a honeycomb structure. That is, ring 14 includes a number of hexagon cells formed in a honeycomb structure (also including both whole hexagons and partial hexagons). The descriptions, examples, and alternatives provided above with respect to ring 12 and the hexagon cells of ring 12 also apply to ring 14 and the hexagon cells of ring 14 (e.g., the same types of shapes, materials, and sizes provided for ring 12 and the cells of ring 12 may also be used for ring 14).

Also, as with ring 12, the outer edge of ring 14 is also formed of a conductive material, such as the conductive material used to form the walls of the hexagon cells. In the illustrated embodiment, the inner edge of ring 14 does not form a straight edge like the outer edge of ring 14; however, in an alternate embodiment, the inner edge may also be formed of a conductive material to form a straight edge. The conductive materials used to form the outer edges, if present, or inner edges, if present, of ring 12 or ring 14 may be the same conductive material used to form the walls of the hexagon cells. Alternatively, a different conductive material may be used.

In one embodiment, a width 39 of ring 14 is approximately 5-7 hexagon cells. In alternate embodiments, width 39 may be smaller or larger to accommodate fewer or more hexagon cells. In one embodiment, width 39 is in a range of approximately 1 to 10 microns. Also, in one embodiment, width 37 is approximately half of width 39. Also, note that the hexagons may be any size, depending on the desired value of width 39 and the desired number of rows of hexagons. For example, in one embodiment a width of a hexagon cell may be approximately one micron. In one embodiment, the cells of ring 12 are of the same size and shape as the cells of ring 14; however, in alternate embodiments, different sized or shaped cells may be used for each ring.

In the illustrated embodiment, rings 12 and 14 are separated by a gap 24 having a width 38. In one embodiment, width 38 is in a range of approximately 1 to 10 microns. In the illustrated embodiment, gap 24 is substantially uniform between the rings. In the illustrated embodiment, gap 24 is filled with one or more dielectric materials. As an alternative embodiment, the gap can be filled with hexagon shaped cells like in rings 12 and 14, thus combining rings 12 and 14 into a wider ring.

FIG. 3 illustrates a cross section taken across rings 12 and 14 (from FIG. 2), through cell walls 70 to 78, in accordance with one embodiment of the present invention. Semiconductor die 10 includes a substrate 42, contact layer 45, and a plurality of via layers (such as via layer 44) and metal layers (such as metal layer 46) overlying substrate 42. In active area 22, contact layer 45 provides electrical connections to devices in substrate 42, and the via layers and metal layers allow for the routing of electrical signals between contact layer 45 and other devices in substrate 42 and between contact layer 45 and uppermost metal layer 46. The cells of rings 14 and 12 are formed in contact layer 45, and in the plurality of via layers and metal layers. The structures and shape of the rings formed in the via layers may be similar to the structures and shape of the rings formed in the metal layers. In other embodiments, the structures and shape of the rings formed in the via layers may be different from the structures and shape of the rings formed in the metal layers. For example, the rings formed in the via layers may be of different polygon shape or different wall thickness than the rings formed in the metal layers. In other embodiments, the rings formed in one via layer may be of different polygon shape or different wall thickness than the rings formed in the other via layers.

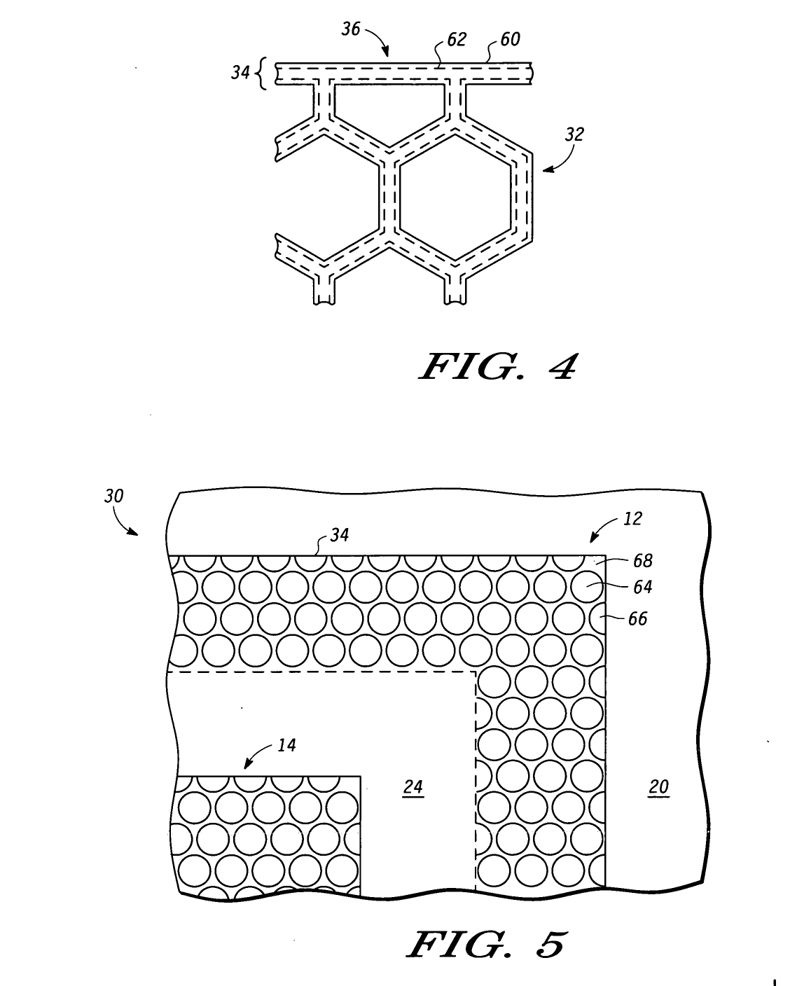

Each vertical stack of cell wall portions (such as cell wall portion 48 of via layer 44 and cell wall portion 50 of metal layer 46) forms a wall of a cell within rings 12 and 14. Referring back to FIG. 2, the cross section is taken through walls 70 to 75 (through 4 complete cells and one partial cell of ring 14), and through walls 76 to 78 (through 2 complete cells of ring 12). In the illustrated embodiment, note that the cell wall portions are continuous in each metal and via layer (as can be seen in FIG. 2, and as will be seen below in reference to FIG. 4). Alternatively, as will be described further below, the cell wall portions may be continuous in the metal layers and not continuous in the via layers.

Note that the cell wall portions in each via layer (such as cell wall portion 48 of via layer 44) and the cell wall portions in each metal layer (such as cell wall portion 50 of metal layer 46) are formed as the vias and metal portions (i.e. routing metal) for the interconnection and active circuitry of active area 22 are formed. Therefore, as the vias and metal interconnects are formed in forming the active circuitry, the cell wall portions in the via layers and metal layers of rings 12 and 14 are also formed. Note that conventional processing and materials may be used to form the cell wall portions in the via layers and the cell wall portions in the metal layers of rings 12 and 14.

In one embodiment, the cell wall portions in the via and metal layers include copper. Alternatively, other conductive materials, such as aluminum, gold, or tungsten, or any combination of conductive materials may be used. Note also that the cell wall portions in the via and metal layers may also include other materials or layers as needed, such as, for example, barrier and adhesions layers, as known in the art. Each via layer and metal layer also includes a dielectric material in which the cell wall portions are formed (such as dielectric 54 and dielectric 56, respectively). For example, contact layer 45 overlying substrate 42 may include PSG (phosphate-doped silicon glass), the middle layers (all layers excluding contact layer 45, via layer 44, and metal layer 46) may include a low-K dielectric or a porous low-K dielectric, and the upper layers (via layer 44 and metal layer 46) may include a tetra-ethyl orthosilicate (TEOS) formed oxide. Therefore, note that the dielectric filling within each cell may include different types of dielectric materials.

Also, note that any number of metal and via layers may be used, depending, for example, on the number of layers needed to form the circuitry and interconnection of active area 22. Therefore, note that by stacking the cell wall portions of the via and metal layers, walls of the cells (such as walls 70 to 78) may be formed extending down to substrate 42. Note that in the illustrated embodiment, the cell wall portions in the via layers are thinner than the cell wall portions in the metal layers. In alternate embodiments, the cell wall portions in the via layers and in the metal layers may have different sizes and may also have any shape.

Semiconductor die 10 also includes a passivation layer 58 overlying the uppermost metal layer (metal layer 46 in the illustrated embodiment). In the illustrated embodiment, passivation layer 58 includes openings which expose the cell wall portions of metal layer 46 of ring 12. In one embodiment, the openings in passivation layer 58 may be discontinuous within passivation layer 58. In another embodiment, the opening in passivation layer 58 provides a honeycomb shape overlying the cell wall portions of metal layer 46 of ring 12. These openings are then capped or filled with a conductive material 52 (also referred to as caps 52), such as, for example, aluminum. Alternatively, other conductive materials may be used.

In one embodiment, ring 12 may be referred to as a crack stop ring which prevents passivation cracking and the propagation of these cracks. For example, referring to FIG. 3, the openings in passivation layer 58 and caps 52 within ring 12 prevent cracks and propagation of cracks in passivation layer 58. In one embodiment, ring 14 may be referred to as a seal ring which prevents the ingression of moisture into the active area and which helps prevent or reduce delamination propagation. Therefore, in the illustrated embodiment, two separate rings are used to protect the active area. However, note that unlike dual ring schemes currently used in the art today (as was described above), the edges of theses crack stop and seal rings are not simply continuous lines of metal, but are formed using a number of polygon or circular shaped cells.

In an alternate embodiment, the gap separating these rings 12 and 14 can be eliminated and these two rings can be combined to form a single ring (which at least partially surrounds the active area) to protect the active area. That is, the protective periphery region of semiconductor die 10 may include a single ring which may perform some or all of these protective functions. In this embodiment, the passivation layer above the outer cells within the single ring area may include openings with caps (such as caps 52 of FIG. 3) to prevent passivation cracks and propagation. Also note that in yet another alternate embodiment, more than 2 rings may be used, as needed.

FIG. 4 illustrates a more detailed top down view of cells 32 and 36 of FIG. 2. The top metal layer, as seen in FIG. 3, corresponds to metal layer 46 where, as discussed above, the cell wall of metal layer 46 is typically wider than the underlying cell wall of via layer 44. Therefore, as can be seen in FIG. 4, the uppermost structure 60 (formed within metal layer 46 and including cell wall portion 50) provides a honeycomb shape with the walls having a first thickness while the underlying structure 62 (formed within via layer 44 and including cell wall portion 48) also provides a honeycomb shape but with walls having a second thickness thinner than the first thickness (as illustrated by the dotted lines). In the illustrated embodiment, edge 34 has the same width as the walls of the complete hexagon cells. However, in alternate embodiments, edge 34 may have a different width in comparison to the walls of the complete hexagon cells.

Note that in the illustrated embodiment of FIG. 4, underlying structure 62 is a solid, continuous structure within via layer 44. However, in alternate embodiments, underlying structure 62 may be discontinuous within the via layer. For example, a plurality of discrete vias or cell wall portions (of any size and shape) may be used within via layer 44 to connect upper structure 60 to the honeycomb shaped metal structure which would be formed in the metal layer immediately below via layer 44. Therefore, each structure (such as structure 62) in the via layers may be formed using a plurality of discrete cell wall portions or vias rather than forming a solid continuous structure. Note that, in alternate embodiments, the structure in the metal layers (such as structure 60) may also be discontinuous.

FIG. 5 illustrates an alternate embodiment in which circle shaped cells (such as circle shaped cell 64 and partial circle shaped cell 66) are used instead of hexagon cells. That is, FIG. 5 illustrates an enlarged view of area 30 of FIG. 1 in accordance with an alternate embodiment. Note that areas 68 surrounding each circle correspond to the metal or conductive walls of the circle shaped cells, and the circle shaped cells of FIG. 5 are filled with a dielectric material or combination of dielectric materials (as was described above in reference to FIG. 2). Therefore, note that the descriptions for materials, formation, sizes, and alternatives provided above with respect to the hexagon cells also generally apply to the circle shaped cells of FIG. 5.

Note that the use of a polygon shaped cell or circular cell may provide improved crack stop capability and better stress protection. For example, similar to the bee hive of honeycombs demonstrated in nature, the honeycomb or hexagon shaped cell structure surrounding the semiconductor die may provide maximum strength with a minimal amount of conductive material, such as copper. This may therefore provide maximum capability to strengthen die peripheral area. Similarly, a circular cell filled with dielectric material may also provide improved crack stop ability. Also, note that in some embodiments, the actual etching process in forming the hexagonal cell walls would round off the corners of the hexagons, thus making the hexagon close to a circle shape. These rounded hexagon shaped cells not only have good strength, but also are good in preventing crack from propagation. Also, adjusting the ratio of cell wall thickness and cell size can provide a way to control the density of the conductive material used to form the protective rings. Thus, each polygon shaped cell can serve as an individual crack-stop structure and prevent cracks from further propagating into the active circuitry region. This may therefore result in improved reliability.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A die for an integrated circuit, comprising:
an active area; and
a first ring in a peripheral region of the die at least partially surrounding the active area, wherein the first ring comprises a plurality of polygon shaped cells.

2. The die of claim 1, wherein each of the plurality of polygon shaped cells has a metal wall.

3. The die of claim 2, wherein each of the plurality of polygon shaped cells has a dielectric material inside the metal wall.

4. The die of claim 3, wherein the dielectric material is a low-K dielectric material.

5. The die of claim 1 further comprising a second ring at least partially surrounding the first ring, wherein the second ring comprises a plurality of polygon shaped cells.

6. The die of claim 2, wherein the metal wall comprises at least one of copper, aluminum, tungsten, and gold.

7. The die of claim 1, wherein the each of the polygon shaped cells is at least one of pentagon shaped. hexagon shaped. and octagon shaped.

8. The die of claim 1 further comprising a substrate and wherein the plurality of polygon shaped cells extend to the substrate.

9. A die for an integrated circuit, comprising:
an active area;
a first ring in a peripheral region of the die at least partially surrounding the active area, wherein the first ring comprises a plurality of polygon shaped cells; and
a second ring at least partially surrounding the first ring, wherein the second ring comprises a plurality of polygon shaped cells.

10. The die of claim 9, wherein each of the plurality of polygon shaped cells has a metal wall.

11. The die of claim 10, wherein each of the plurality of polygon shaped cells has a dielectric material inside the metal wall.

12. The die of claim 11, wherein the dielectric material is a low-K dielectric material.

13. The die of claim 10, wherein the metal wall comprises at least one of copper, aluminum, tungsten, and gold.

14. The die of claim 9, wherein the each of the polygon shaped cells is at least one of pentagon shaped, hexagon shaped, and octagon shaped.

15. A die for an integrated circuit, comprising:
an active area; and
a first ring in a peripheral region at least partially surrounding the active area, wherein the first ring comprises a plurality of circle shaped cells.

16. The die of claim 15, wherein each of the plurality of circle shaped cells has a metal wall.

17. The die of claim 16, wherein each of the plurality of circle shaped cells has a dielectric material inside the metal wall.

18. The die of claim 17, wherein the dielectric material is a low-K dielectric material.

19. The die of claim 15 further comprising a second ring at least partially surrounding the first ring, wherein the second ring comprises a plurality of circle shaped cells.

20. The die of claim 16, wherein the metal wall comprises at least one of copper, aluminum, tungsten, and gold.

21. A method of forming a die for an integrated circuit, comprising:
providing an active area; and
providing a first ring in a peripheral region of the die at least partially surrounding the active area, wherein the first ring comprises at least one of a plurality of polygon shaped cells and a plurality of circle shaped cells.
